(19) United States
(12) Patent Application Publication
(10) Pub. No.: US 2024/0149956 A9
(43) Pub. Date: May 9, 2024

(54) COAXIAL BEVERAGE KEG CONNECTOR COMPRISING A BALL JOINT

(71) Applicant: JOHN GUEST INTERNATIONAL LIMITED, West Drayton, Middlesex (GB)

(72) Inventors: Joshua SMITH, West Drayton, Middlesex (GB); Glen ANSELL, Edgware, Middlesex (GB)

(21) Appl. No.: 17/288,049

(22) PCT Filed: Oct. 10, 2019
(86) PCT No.: PCT/GB2019/052878

§ 371 Date: Apr. 23, 2021

(30) Foreign Application Priority Data
Oct. 24, 2018 (GB) 1817289.0

(51) Int. Cl. B62D 35/00; H01Q 1/32; H01Q 1/42; H01Q 5/307; H01Q 9/04; H01Q 21/08; H04B 1/3822

(52) U.S. Cl. CPC B62D 35/007; H01Q 1/3275; H01Q 1/42; H01Q 5/307; H01Q 9/0407; H01Q 21/08; H04B 1/3822

(57) ABSTRACT

An coaxial keg connector comprising a main body (1) made of plastic and having a first inlet port (3) and a second inlet port (3) receiving a stem (2). A coaxial outlet (10) comprises an outer outlet port (11) in communication with the first inlet port (3) and an inner outlet port (12) in communication with the second inlet port. The stem (2) comprises a tubular body with a main axis (31) with an inlet and a connector for attachment to the keg at one end. The second end of the stem opposite to the first end has an outlet in fluid communication with the inner outlet port (12) and comprises a ball joint (61) rotatably mounted in and sealed with respect to the main body (1) so as to be rotatable (12) about the main axis (31) of the tubular body and rotatable (67, 68) to a limited extent about axes perpendicular to the main axis.

### FIELD OF THE INVENTION

The present invention relates to a spoiler assembly for a vehicle. Aspects of the invention also relate to a vehicle having a spoiler assembly.

### BACKGROUND OF THE INVENTION

Motor vehicles increasingly require advanced data communication capabilities. Data throughput and signal integrity is thus of particular importance given the large amounts of data expected to be received and transmitted. For example, navigation, voice communication, multimedia and cellular data may all need to be received and/or transmitted by the vehicle systems. With this in mind conventional communication systems for motor vehicles typically use an antenna located on the roof of the vehicle and enclosed in a protective housing. The antenna is connected to a radio unit located about the cockpit of the vehicle via radio frequency (RF) coaxial cable. The radio unit contains the necessary electronics for demodulating and processing the RF signal received by the antenna and providing a signal output (e.g. data or audio) to vehicle systems. For example, the radio unit may include a receiver for demodulating the signal and other circuitry for processing the demodulated signal to provide a digital signal output. This arrangement allows for the antenna to be advantageously located in an external housing on the roof to provide good signal reception. The housing protects the antenna and may be manufactured to provide transparency to radio frequency signals.

### SUMMARY OF THE INVENTION

The present invention provides a spoiler assembly for a vehicle, said assembly comprising a spoiler housing, one or more antennas, and a radio unit. The radio unit comprises receiving means for demodulating a signal received at the one or more antennas and signal processing means for processing the demodulated signal to provide a digital output signal for a data network. The one or more antennas and the radio unit are disposed within the spoiler housing.

The inventors have recognised that the use of coaxial cabling to conventionally provide antenna signals to a radio unit is problematic because of the signal attenuation associated with such cables. This is a particular issue with high frequency signals such as those used in modern cellular communications where dielectric attenuation and power loss can be significant. Where such an arrangement is used, the location of the antennas on the upper surface of the roof becomes increasingly necessary in order that the signal received by the antenna is powerful enough to overcome signal attenuation caused by the RF coaxial cabling. Further, coaxial cabling is expensive and heavy which adds to the manufacturing costs and adds unwanted weight to the vehicle cable harness. Also, having antennas located in so-called shark fin shaped enclosures on the roof is inevitably detrimental to the aerodynamic performance of the vehicle. Further, despite attempts to make such structures pleasing to the eye they are still detrimental to the appearance of the vehicle. If the antennas are placed within the vehicle cabin then not only is the reception is compromised and the attenuation problem with coaxial cable is exacerbated, but the available headroom in the vehicle is also unacceptably reduced.

According to the above aspect of the invention a radio unit is located in the spoiler together with the one or more antennas. As a result, minimal or no RF coaxial cabling is needed to connect the antennas to the radio unit and any associated circuitry. Thus, there is minimal signal attenuation before the signal is demodulated by the receiving means.

Further, the processing means processes the signal to produce a digital output signal for a data network. Accordingly, data network cabling can be used to transport the digital signals, for example, to a head unit located at an opposing end of the vehicle. Digital signals transported by network cabling are less prone to signal attenuation than RF signals transported by coaxial cable. This means that the signal integrity is maintained. Further network cabling is lighter and lower cost than RF coaxial cabling, thereby reducing the overall cost and weight of the vehicle wiring harness. The invention, therefore, allows the antenna(s) to be discretely hidden from view in the spoiler with no or little aerodynamic penalty while still providing good output signal quality, and reducing or keeping low the overall mass and cost of the wiring harness within the vehicle.

Advantageously, the spoiler assembly may comprise a plurality of antennas. Thus, the antennas can be configured to receive a range of different signal types or to be configured in an array to provide better transmission or reception capabilities. For example, the plurality of antennas may include a first antenna configured to receive signals in a first frequency band and a second antenna configured to receive signals in a second frequency band. Preferably, the receiving means includes a corresponding receiver for demodulating signals from each of the first and second antennas. Thus, the antennas can receive different signal types located in different frequency bands. For example, the antennas may include one of a 3G, 4G (LTE), GNSS, V2X, DAB and SDARs antenna. The receiving means includes means for demodulating at least one of a 3G, 4G (LTE), GNSS, V2X, DAB and SDARs signal. Thus, a corresponding receiving means is provided for demodulating the different received signals and making the radio unit suitable for receiving a wide range of modern communication signal standards.

One or more of the antennas may be a patch antenna or a PCB antenna. Patch antennas have the advantage of being compact and being planar so as to be formable upon a PCB surface. A PCB antenna is advantageous because the conductive tracks may be patterned and configured on the PCB surface to save space and the PCB may be oriented according to their polarisation e.g. vertically oriented for vertical polarisation.

A plurality of the antennas may be laterally spaced within the spoiler housing. This allows spatial decorrelation between received signals. In one embodiment, a plurality of antennas are cellular antennas which are configured to function as a multiple-input and multiple-output (MIMO) antenna array. Spatial multiplexing of this type advantageously permits an increased throughput of data to be achieved using the antenna array and a suitable receiver. This is particularly useful in cellular applications where the amount of data transmitted and received may be significant. Using an array also assists in diversifying the reception frequencies. For example, some antennas can be configured for lower frequencies and some for higher frequencies. This not only helps with signal reception but also with packaging the antennas within the limited space within the spoiler housing.

In an embodiment, the radio unit also includes transmission means for modulating a signal and providing it to one or more of the antennas. For example, the radio unit may include a transceiver for performing the functionality of at least the receiving and transmitting means. The transmission means may include means operable to modulate at least one of a 2G, 3G, 4G (LTE), 5G, GNSS, and V2X signal for transmission. In another embodiment, the V2X transceiver is for V2V communications and is compliant with dedicated short-range communications (DSRC) standards such as IEEE 802.11p.

Preferably, the signal processing means is arranged to provide an output signal for transmission via Ethernet. For example, the demodulated signals may be arranged into data packets with suitable header information to allow routing within the network by a network switch or hub. Further, Ethernet is advantageous because signals may be transmitted on twisted pair cable such as category 5 (Cat 5, 5e, 6) cable which is lightweight and low cost compared to RF coaxial cabling.

Further advantageously, the output data signal is suitable for Broad R-Reach Ethernet. BroadR-Reach is an Ethernet physical layer standard which is optimised for use in automotive connectivity applications. It uses a signalling scheme with a higher spectral efficiency than that of conventional Ethernet 100BASE-TX but has a more limited bandwidth. It also uses a highly efficient scrambling algorithm which is important for security of communications within the vehicle. The lower bandwidth is preferable in certain automotive applications because of reduced cross talk which is important for compliance with the strict automotive electromagnetic emission standards. Importantly, however, it allows use of unshielded single twisted pair cabling which allows the wiring harness to even lighter and more cost effective than traditional Ethernet cabling and for full integration with other electronic systems in the vehicle.

In an embodiment, the signal processing means is operable to send and receive control signals via the network. This is particularly advantageous where multiple requests from vehicle electronic systems (for example, an infotainment system) might be received for demodulated data from the antennas. By providing control functionality at the radio unit, the radio unit processing means can effectively act as a switch or hub for efficiently controlling data and requests from networked vehicle systems. Advantageously, the signals transmitted by the radio unit may be encrypted by the signal processing means and signals received by the radio unit may be decrypted by the signal processing means, for example by public/private key or shared key protocols, to provide secure communications within the vehicle.

The radio unit may also include an eCall unit which may be integrated with an LTE transceiver. The eCall unit is thereby advantageously located in the spoiler and is relatively protected in the case of at least front and side crash impacts. This allows eCall safety compliance without the need for the weight, cost and space taken by the conventional solution of a separate and protected eCall box located elsewhere in the vehicle.

Preferably, the radio unit is a circuit formed on a printed circuit board. Circuit housing may be provided for enclosing the printed circuit board within the spoiler housing. Thus, the circuit can be effectively packaged on a PCB and protected within the housing. As well as physical protection, electromagnetic emissions or cross talk with other vehicle systems may be reduced. In addition, the housing may provide a further degree of design freedom for thermal management of the circuit and antenna package, e.g. by providing insulation or a heat sink to reduce solar heating effects. In an embodiment, at least one antenna is contained formed on the circuit board with the radio unit. Integrating one or more antennas with the radio unit on a PCB makes the overall antennas and radio unit package more compact and lightweight allowing it to fit efficiently within a void within the spoiler housing.

At least one antenna of the assembly may be oriented substantially vertically with respect to the spoiler and arranged to extend downwardly from at a surface of the spoiler housing. Vertical orientation of certain antenna types is necessary depending on the antenna polarization and to provide proper directivity. Having the antennas arranged to extend downwards from the spoiler housing, is contrary to the convention of upwardly pointing shark fin antennas that have been used in the past to optimise reception. By having the antennas point downwards, they can be effectively hidden from view from an observer while sufficient reception can be provided. In particular, signal attenuation or losses resulting from the downward orientation whereby signals which have to pass through the car body, may be compensated at least to some extent by providing a means to demodulate the signals in the spoiler. The same advantages apply to transmitted signals as there is the attenuation that would result from transporting RF signals from the head unit to the antennas is avoided.

In an embodiment, the one or more antennas extend downwardly from a surface within the spoiler. The spoiler housing may comprise a planar upper surface, and the antenna elements may be arranged to project downwardly with respect to the planar upper surface. In another embodiment, the spoiler housing consists of an upper portion and a lower portion and the antennas extend downward from a surface upon an upper portion of the spoiler housing. In an embodiment, said surface is one of a horizontal plane within the spoiler housing, an inner surface of the spoiler housing and a bottom surface of the spoiler housing.

Preferably, the spoiler housing includes an antenna enclosure arranged to enclose the one or more downwardly extending antennas. The antenna enclosure for the one or more downwardly extending antennas may include a lower portion of the spoiler housing which may be isolated, for example sealed, from an upper portion of the antenna housing. The upper portion and the lower portion may be isolated, for example sealed, from each other, save for an electrical connection passing from the upper portion to the lower portion.

In a further aspect of the invention there is provided a vehicle comprising a spoiler assembly according to any of the above described aspects and embodiments.

The vehicle may comprise a head unit (e.g. an infotainment unit) located in the vehicle, said head unit comprising an electronic control unit for transmitting and receiving signals to and from the radio unit. The head unit may be located in the vehicle cabin and, for example, about the instrument panel, centre console or an over-head unit.

This permits data requests and receipt of demodulated data from the radio unit located in the spoiler. Different functions of the infotainment unit such as digital radio, GPS, or cellular data may obtain the necessary cellular and GPS data across the network from the radio unit. Thus, a multi-functional infotainment unit is made possible within the vehicle.

The vehicle may include a wired Ethernet connection between the head unit and the radio unit. Ethernet cabling can, therefore, be used which is light and cheap and provides a robust data connection from the spoiler radio unit and the head unit elsewhere in the vehicle. In principle, however, a wireless connection could be provided from the radio unit to the head unit (infotainment unit), for example, using the WiFi standard (e.g. in accordance with one of the existing IEEE 802.11 standards including the vehicular standard 802.11p) if appropriately configured WiFi transceivers were provided at both the head unit and radio unit. Preferably, an Ethernet switch is provided in the vehicle to route signals between the head unit and the radio unit and to properly integrate the head and radio units with the other electronic systems (e.g. ECUs) in the vehicle.

### BRIEF DESCRIPTION OF THE DRAWINGS

In order that the present invention may be more readily understood, embodiments of the invention will now be described, by way of example, with reference to the accompanying drawings, in which:

FIG. 1 is an illustrative view of a vehicle including a spoiler assembly according to the present invention;

FIG. 2 is a top-down view of the vehicle showing schematically a spoiler housing having a radio module and antenna assembly disposed therein;

FIG. 3 is a schematic showing an integrated radio module incorporated into the spoiler in an embodiment of the present invention;

FIG. 4 is an overhead view showing the components of the spoiler assembly in an embodiment of the invention;

FIG. 5 shows the spoiler assembly from a perspective viewpoint;

FIGS. 6a, 6b and 6c show side profile cross-sections of a spoiler assembly when viewed from left-to-right in respective embodiments of the invention;

FIGS. 7a and 7b show different spoiler housing configurations according to embodiments of the invention; and

FIG. 8 illustrates how the radio unit is enclosed within circuit housing located within the spoiler in an embodiment of the invention.

### DETAILED DESCRIPTION OF THE INVENTION

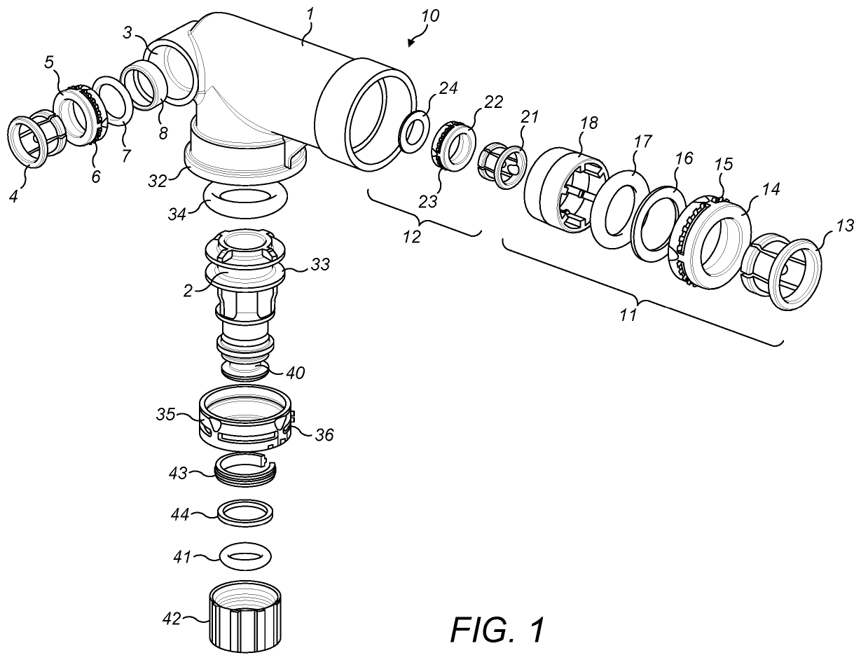

The vehicle 100 in FIG. 1 is a motor vehicle that includes a rear spoiler 101 mounted at the rear of the vehicle and extending from the roof of the vehicle to provide an aerodynamic surface substantially aligned with the roof of the vehicle to provide a continuous surface. A lateral axis 102 and a longitudinal axis 103 of the vehicle are indicated as shown and references to the lateral and longitudinal axes herewith are with respect to these axes of the vehicle. Although, a motor car is shown, the invention is applicable to other types of vehicle that may utilise a spoiler.

As shown in FIG. 2, a radio unit 201 and an antenna assembly 202 are located within the rear spoiler 101. The antenna assembly includes one or more antennas coupled to the radio unit 201 which includes respective receivers (receiving means) for demodulating signals received from the one or more antennas. Further, the radio unit 201 is configured so as to process the demodulated signals to provide an output data signal (signal processing means). The output data signal is provided to network cable 203 for transmission to a head unit 204 located about the dashboard 205 in the cabin 206 of the vehicle 100. The head unit 204 preferably includes a digital signal processor for processing digital signals such as those received via the network cable 203 and a wireless connectivity module.

The term “radio unit” is used throughout this description; however, it will be appreciated that the expression “communication unit” or “communication module” could also be used.

The one or more receivers may each also function as a transmitter i.e. a transceiver and thereby be further operable to modulate data signals for transmission via the antenna(s) in addition to demodulation of received signals.

Preferably, the signals from the radio unit 201 conform to the Ethernet standard (10BASE-T, 100BASE-TX, 1000BASE-T, for example) and the cabling is Cat 5, 5E, 6 cabling. Preferably, the BroadR-Reach automotive Ethernet standard is used both in transmission and reception of signals between the radio unit 201 and the head unit 204 and the network cabling 203 consists of unshielded single twisted pair cabling. Advantageously, this provides a robust and efficient signalling scheme for automotive systems. However, as will be appreciated by those skilled in the art, other types of cabling suitable for network data transmissions may also be used. For example, other types of shielded or unshielded twisted pair, fiber-optic or even coaxial cable (despite the aforementioned disadvantages) could be used to provide the data connection between the radio unit and the head unit. Alternatively, each of the radio unit 201 and the head unit 204 may be furnished with a WiFi transceiver and so that the radio unit and the head unit may communicate wirelessly. This has the advantage of foregoing the need for any associated network cabling, thus reducing the mass of the vehicle further.

Advantageously, an Ethernet switch 207 may be provided between the radio unit 201 and the head unit 205. The Ethernet switch 207 is configured to control data communications between the various systems (not shown) of the vehicle and provide security and diagnostic functions. In addition, the radio unit 201 may be arranged to provide and/or receive different digital signal types. In this embodiment, the radio unit 201 is also capable of transmitting and receiving an A2B (Automotive Audio Bus®) digital signal to and from an overhead unit 208 provided in the cabin via cabling 209. The A2B cabling 209 may be used to transport critical digital audio to and from the radio unit 201 via the antenna assembly. In an embodiment, the overhead unit 208 includes occupant controls for generating an eCall request, for example, which is transmitted to the radio unit via the A2B connection 209.

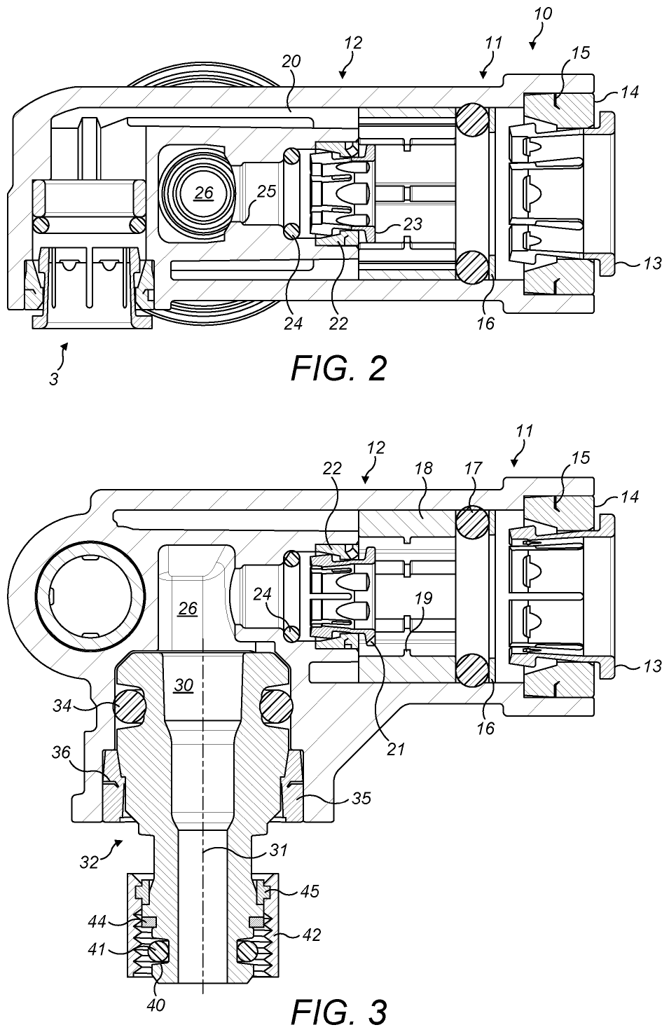

FIG. 3 shows an embodiment in which the radio unit 201 of FIG. 2 includes a plurality of receivers. These include an SDARs 301-1, GNSS 301-2, V2X 301-3 and an LTE 301-4 receiver. Corresponding SDARs 302-1, GNSS 302-2, V2X 302-3 and LTE 302-4 antennas are provided which are coupled to a respective one of the receivers 301-1, 301-2, 301-3, 301-4. These antennas may be any configuration of antenna that is suitable for receiving and transmitting signals in the bandwidth applicable for the respective function. The antennas may be PCB or patch antennas, for example, and one or more may be located separately from the radio unit or may be integrated in a circuit board with the modules of the radio unit 201. Each patch antenna may be formed by a patch or area of conductive material on a substrate. Typically, the patch antenna may be rectangular but this is not necessarily the case. Other shapes are possible, such as a polygonal shape, a T-shape, an L-shape etc. The antennas may be vertically oriented with respect to the spoiler assembly when installed on a vehicle. For example, the antenna surface may be perpendicular to a surface of the spoiler assembly such as an inner wall of the spoiler housing, the plane in which the radio unit 201 is secured or a lower surface of the spoiler housing. Generally, the orientation of the antennas is configured to match the orientation of the transmission antennas, i.e. at a base station or the satellite. For example, satellite broadcast and transmission systems would typically be circularly polarized making a patch antenna suitable for communication and cellular base station aerial would be vertically polarized making a vertically oriented antenna a suitable choice.

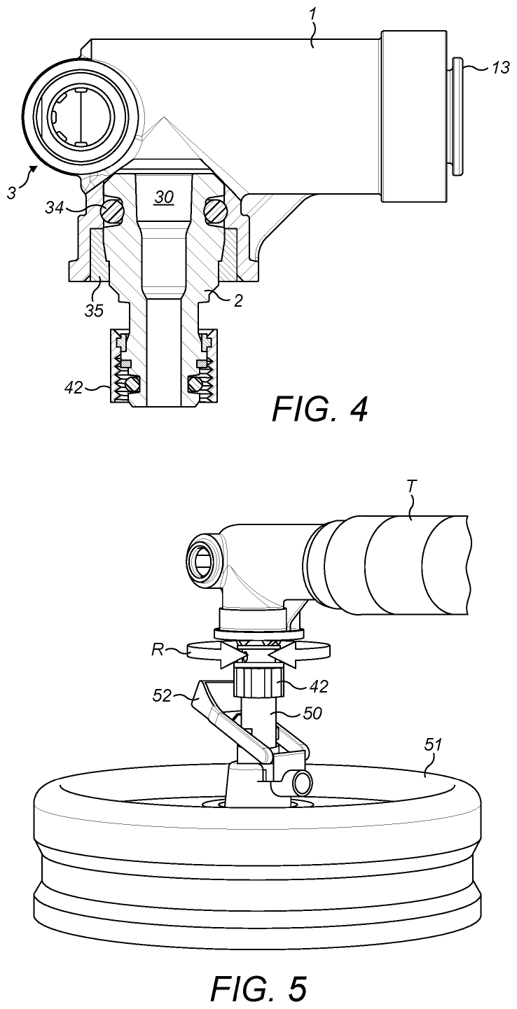

The LTE (Long Term Evolution)/4G antenna 302-4 may comprise an array of antennas arranged in so as to provide spatial diversity including MIMO (multiple-input and multiple-output) functionality to improve data throughput. That is, where one or more of the antennas in the array is used to transmit data and another is used to transmit data. Further, the signal to noise ratio of the antenna may be improved. Such an arrangement is shown in FIG. 4 and will be explained in more detail below. The LTE antennas are used for telecommunications in a 4G telecommunications band, for example, with a highest frequency of 2.6 GHz. In this embodiment, an LTE/4G antenna (or antenna array) and transceiver is shown but other cellular telecommunications bands could be used such as 2G, 3G and 5G.

In this embodiment, the antennas 302-1, 302-2, 302-3 and 303-4 are located within the spoiler and are either connected to the radio unit by a short length of coaxial cable or are formed directly on a PCB with the other circuit elements of the radio unit 201. Because the antennas and radio unit are proximate within the spoiler area, the lengths of coaxial cable is short and signal attenuation from antenna to the radio unit is negligible.

Where a receiver relates to a communications function such as GNSS 301-2, V2X 301-3, or 4G/LTE 301-4, two-way (duplex) data communication (transmission and reception) is desirable. Accordingly, the receiver will preferably also include a transmission function so that these modules are transceivers. The SDARs receiver 301-1 is for broadcast reception of digital radio signals so typically only the ability to demodulate received signals is required. Other broadcast antenna and receiver pairs may also be used such as for DAB reception.

The receivers/transceivers 301-1, 301-2, 301-3, 301-4 are connected to a processor 303 which is further connected to Ethernet interface 305. The processor is configured to provide a gateway function that takes the demodulated digital signals from the transceivers and package the data contained for transmission via the Ethernet interface 305. The processor 303 is also capable of receiving data requests via the Ethernet interface 305. Other functions that may be provided are diagnostic and security functions, such as encryption or decryption of data that is to be transmitted and received within the car. For example, a cryptographic key system may be used for transmissions in the vehicle data network to protect communications between vehicle systems from being intercepted and manipulated by third parties. In effect, the processor can provide some of the functionality of an Ethernet hub or gateway controlling the flow of data signals between the components of the radio unit to and from the vehicle data network. The Ethernet interface is connected to the Ethernet switch 207 by the Ethernet connection 203. As shown, the Ethernet switch is connected to the Head unit 204. The Head Unit 204 in this embodiment is an infotainment unit which includes an audio module 311 and a connectivity module 310. The connectivity module provides Bluetooth and/or WiFi connectivity, for example, with mobile devices.

In addition, an A2B (Automotive Audio Bus®) master module 304 is provided which is capable of receiving and transmitting control and audio data signals from and to the LTE transceiver 301-4. The A2B master 304 is connected to a corresponding A2B slave module 306 in the overhead unit 208. The A2B connection uses unshielded 2-wire cabling and is thus lightweight and inexpensive compared to shielded digital audio cabling. The A2B slave 306 is connected to an audio unit 307 and a control unit 308. The control unit 308 generates control information based on user inputs received via the user controls on the overhead unit. In addition, the control unit 308 is operable to transmit and receive control data from other ECUs in the vehicle and in particular from an ECU 309 associated with a vehicle safety system. In an embodiment, the LTE transceiver 301-4 is further configured to function as an eCall module 312 for making emergency transmissions in the event of a crash event via a cellular connection. Thus, the A2B connection provides an effective means to transmit and receive digital audio for providing the eCall functionality. Further, by providing the eCall module 312 in the spoiler certain compliance criteria associated with protecting the eCall box in the event of a front, side or rear crash may be complied with. The eCall unit would otherwise have to be provided in a secure location under a vehicle seat to protect it in the event of a crash and then a wired connection provided to the head unit 204. By having the eCall function in the spoiler it is protected in the event of the most common crash events and RF coaxial connections from transmission/reception antennas are not needed. Thus, the need for a separate eCall box is avoided thereby reducing complexity, weight and cost of the vehicle assembly. Preferably, the radio unit 201 also includes a back-up battery unit to provide power to at least the eCall function in the event of the main supply failing or being unable to provide energy.

In the embodiment shown in FIG. 3, both A2B and Ethernet are provided for but in certain embodiments the radio unit 201 may communicate with the automotive systems of the vehicle with only one of an Ethernet or A2B connection such that the processor or the A2B module are omitted from the radio unit.

In FIG. 3, the receivers/transceivers 301-1, 301-2, 301-3 and 301-4 are shown as different elements in the schematic. However, in some embodiments at least some of the receiver/transceiver functions may be performed by a processor running an application stack. Further, some or all of the signal processing for providing a digital signal for a data network may be performed by a receiver/transceiver unit itself, forgoing the need for a separate processor. In other words, the receiver/transceiver may be both a signal processing means and a means for demodulating and/or modulating an RF signal. In the extreme, all of the functions of the modules of the radio unit may be performed by a single processor running multiple applications, an ASIC, FPGA or other circuit types or combinations of circuit types known to those in the art.

FIGS. 4, 5 and 6 show how a circuit and antenna assembly such as that shown in FIG. 3 may be packaged as an assembly within a spoiler. FIG. 4 shows the inside of the spoiler 101 from an overhead perspective, illustrating the layout of the components packaged therein. The illustrated assembly includes a printed circuit board 401 that carries a radio unit 201 and an antenna assembly 202 as per FIGS. 2 and 3. The PCB is secured to the inside of the spoiler housing via the mounting holes 410a, 410b, 410c and 410d.

Included on the PCB are a GNSS patch antenna 402 and an SDARS patch antenna 403 both of which are circularly polarized patch antennas formed on a substrate on the PCB. In contrast, a V2X antenna 404, also mounted on the PCB, is oriented perpendicular to the plane of the circuit board and aligned laterally to the vehicle. Perpendicular orientation is used for V2X transmission and reception in order to match the vertical polarization of the base station antennas. Other orientations of antennas are possible depending on the reception requirements for the signal type they are configured to receive.

Four LTE antennas 405-1, 405-2, 405-3, 405-4 are provided which are laterally spaced across lateral axis 102 so as to be spaced across the spoiler housing. The spacing between the LTE antennas is ideally arranged so that there is at least 10 dB of decorrelation between the antennas and so that a multiple-input multiple-output configuration is possible. Thus, the space within the spoiler is optimally utilised to provide an LTE antenna array with high data throughput. Each of the antennas 405-1, 405-2, 405-3, 405-4 is a PCB-type antenna comprising a conductive layer arranged on a substrate and is oriented perpendicular to the plane of the main radio unit PCB 401. They are mounted by means of respective brackets which are fixed to an inner surface of the spoiler. The inner antennas 405-2 and 405-3 are configured to receive high frequencies. For example, for LTE/4G these antennas are configured to receive frequencies at 1.6 GHz and 2.1 GHz.

The outer antennas 405-1 and 405-4 are L-shaped antennas, configured so as to receive low frequencies e.g 700 MHz. The L-shaped configuration allows the additional length of PCB to allow reception of low frequencies in a space compact enough to fit within the spoiler housing. The LTE antennas 405-1, 405-2, 405-3, 405-4 are connectable to the PCB circuit 401 by RF coaxial cabling (not shown) via the connectors 406.

Connectors 407-1 and 407-2 provide A2B and Ethernet connections respectively while connector 407-3 is a power supply connector. A further antenna coaxial connection 408 is provided which in this embodiment provides a connection to a further V2x antenna located elsewhere in the vehicle. This provides reception diversity with the on-board PCB antenna 404 which is has been found to be vulnerable to poor signal reception due to signal reflections in the spoiler cavity. The V2x antenna may be used for system critical communications and accordingly antenna diversity is appropriate. The signal transmitted to the coaxial connection 408 will be subject to some attenuation whereas the on-board antenna will not but the reception/transmission characteristics of the off-board V2x antenna may be better. In some circumstances the on-board antenna with no attenuation will provide the better signal whereas in others the off-board antenna with its better reception may be better. This arrangement, therefore, attempts to provide redundancy and a best of both worlds arrangement for V2x communications.

The receivers/transceiver 301-1, 301-2, 301-3, 301-4 and processor 303, 304 functions of the FIG. 3 schematic are performed by number of IC chips/modules embedded and interconnected on the PCB 401. In this embodiment, a processor 412, and LTE 414, V2x 416, GNSS 418 transceiver IC chips/modules are provided together with and SDARs receiver chip/module 420 on the PCB 401. The LTE chip/module 414 in this embodiment provides both the A2B master and eCall functionality. As will be appreciated, conductive tracks and appropriately configured IC pins (not shown) will provide the connectivity shown in FIG. 3.

Together, the integrated circuit modules provide the functionality of the system architecture shown in FIG. 3. However, other combinations of hardware and software are possible that provide the same functionality of a receiver/transceiver for demodulating/modulating a signal and processing the signal to provide a digital signal output suitable for transmission on a data network. For example, a general purpose processor running a software stack to provide the required functionality or multiple receiver or transmission functions might be consolidated in one or more ICs.

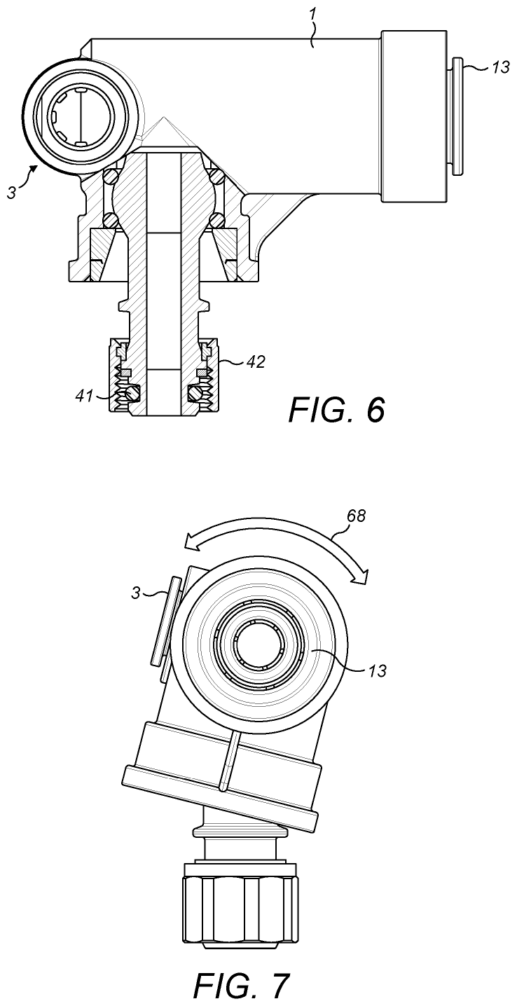

The perspective illustration of FIG. 5 and the side view of FIG. 6a, showing a section view looking into the spoiler from left to right along the lateral axis 102, show how the LTE antennas 405-1, 405-2, 405-3 and 405-4 are disposed within the spoiler housing. As shown, a portion of each LTE antenna projects downwards into a lower portion 501 of the housing. As shown, the portion of the Antenna which projects downwardly from the PCB 401 is greater than portion extending above the PCB 401. The lower portion 501 in this embodiment takes the form of a single downwardly oriented antenna fin forming a portion of the housing. As shown, the laterally spaced antennas are generally aligned with the longitudinal axis 103 which is perpendicular to the lateral axis 102.

By having the vertically oriented antennas 405-1, 405-2, 405-3, 405-4 project downwardly with respect to an upper aerodynamic surface of the spoiler they can be kept out of view of an observer of the vehicle, thus making the vehicle appearance more attractive. By having the antennas project downwards, the forward reception will inevitably require signals to travel through the vehicle itself leading to some degradation in the forward antenna gain. However, this is mitigated, at least to some extent, because the antenna signals do not have to be carried as RF signals on coaxial cable a distance across the vehicle and can be carried instead as data signals on network cabling (or even transmitted wirelessly). In particular, as already discussed, because the radio unit 201 is located in the spoiler housing 101 together with the antenna assembly 202, data networking cable can be used to transport the data signals to a head unit 204 elsewhere in the vehicle. The trade-off between the improved aerodynamics and appearance with the detriment to the forward gain is thus made more acceptable.

In this embodiment, the lower portion 501 is integrally formed with the upper portion 502 of the spoiler housing 101. However, in other embodiments the spoiler housing may be formed of two distinct component parts, one comprising the upper portion 502 and the other the lower portion 501.

The arrangement of the four antennas 405-1, 405-2, 405-3 and 405-4 when configured in this manner is shown in FIG. 7a in a rear view cut-away of the spoiler showing the under fin 701. In other embodiments the lower portion of the spoiler housing may comprise multiple fins each enclosing one or more antennas. An example is shown in FIG. 7b where two downward fins 702a and 702b are provided. The first under-fin portion 702a encloses antennas 405-1, 405-2 and the second under-fin portion 702b encloses antennas 405-3 and 405-4. In a further embodiment, each downwardly projecting antenna may be enclosed in a different antenna fin such that the antennas are isolated from each other. Other configurations of under-fins and antennas are also possible.

In the embodiment shown in FIGS. 5 and 6a, a portion of the antenna resides inside an upper portion of the housing 502. This has the advantage of making use of the available space in the aerodynamic part of the spoiler and minimising the space required by the lower portion 501 of the housing which may be detrimental to the overall weight and aerodynamic performance of the spoiler. However, in other embodiments the entirety of the antenna may project downwardly from or below a plane generally corresponding to a boundary between the upper and lower portion such that substantially the entirety of the vertically oriented antenna elements are contained within the lower portion.

For example, in the embodiment shown in FIG. 6b, the lower portion comprises a downwardly extending antenna fin 601 that is isolated from the upper portion of the spoiler housing by mounting beneath a lower surface 602 of the upper portion 502 of the spoiler housing. One or more of the antennas may be enclosed entirely within the downward antenna fin 601 and are thus mounted beneath the upper portion of the spoiler housing 101. This has the benefit that those antennas in the under-fin portion 601 can be more easily accessed for maintenance and protected. Further, the material for the lower portion enclosing the downwardly extending antennas may be selected to minimise signal attenuation, such that the upper and lower portions may use different materials.

In the above embodiments the antennas 405-1, 405-2, 405-3, 405-4 are oriented vertically within the spoiler assembly but in other embodiments they may project generally downwardly by being oriented at an angle with respect to the vertical axis. This can assist in reducing the downward space required or fitting the antenna within a given geometry of the spoiler housing without unduly compromising antenna reception. For example, FIG. 6c shows an embodiment whereby the antenna is disposed at 45 degrees with respect to the vertical axis. This design freedom can assist in reducing the space required within the spoiler housing and for fitting the antenna within a given geometry of the spoiler housing without unduly compromising antenna reception i.e. due to the change in orientation.

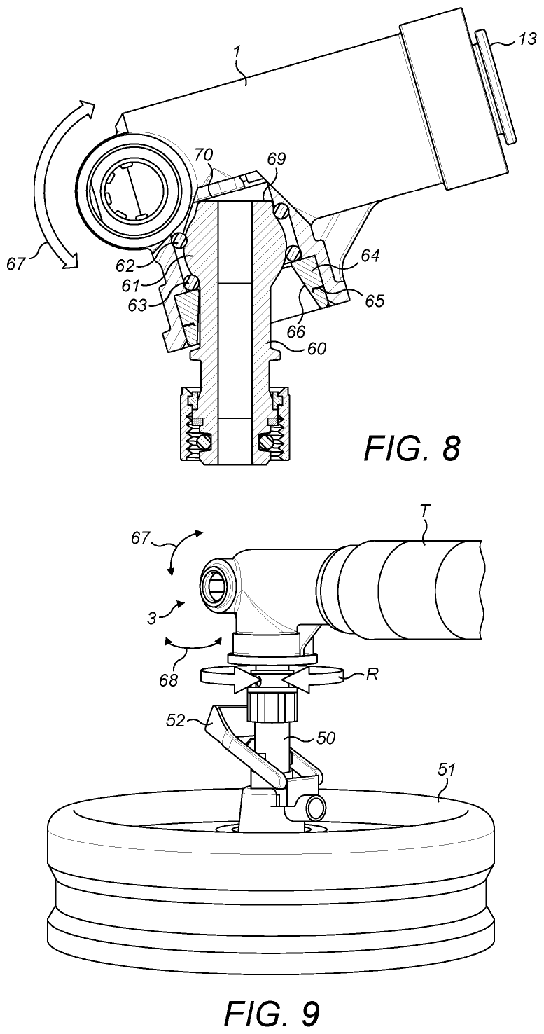

FIG. 8 illustrates how the PCB containing the circuit for the radio unit 201, and some of the antenna assembly 202, may be enclosed within a circuit housing 801 located within the spoiler housing 101. The housing contains a number of ports 802 aligned with the connectors on the PCB so that they may be accessed. Placing the PCB within a circuit housing allows mechanical protection and thermal management of the circuit therein. For example, the material of the circuit housing may be chosen for its mechanical and/or thermal properties and/or a heatsink fins or similar structure (not shown) may be provided with the housing to dissipate heat. This is particularly important given the circuit location in the spoiler where solar loading may increase the thermal load upon the circuit and antenna package.

Although the above embodiments concern an assembly involving four downwardly projecting antennas, it will be appreciated that the invention is not limited to that number. A single antenna or other numbers of downwardly projecting antennas may be provided with the advantages as set out above. Further, although the lower portion has been shown as a downward fin, it will be appreciated that other shapes are possible depending on the aesthetic, aerodynamic and space requirements of the spoiler assembly design.

In the above embodiments a V2X receiver/transceiver and associated antenna is described. V2X signal for transmission. In one embodiment, the V2X receiver/transceiver and antenna are for V2V (vehicle-to-vehicle) communications and are compliant with a dedicated short-range communications (DSRC) standard such as IEEE 802.11p.

1. A spoiler assembly for a vehicle, said assembly comprising:
a spoiler housing;
one or more antennas; and
a radio unit comprising
receiving means for demodulating a signal received at the one or more antennas,
signal processing means for processing the demodulated signal to provide a digital output signal for a data network,
wherein the one or more antennas and the radio unit are disposed within the spoiler housing.

2. A spoiler assembly according to claim 2 comprising a plurality of antennas including a first antenna configured to receive signals in a first frequency band and a second antenna configured to receive signals in a second frequency band.

3. A spoiler assembly according to claim 3, wherein the receiving means includes a corresponding receiver for demodulating signals from each of the first and second antennas.

4. A spoiler assembly according to any preceding claim, wherein the receiving means includes means for demodulating at least one of a 2G, 3G, 4G (LTE), 5G, GNSS, V2X, DAB and SDARs signal.

5. A spoiler assembly according to any preceding claim, wherein the one or more antennas include a patch antenna or a PCB antenna.

6. A spoiler assembly according to claim 5, wherein comprising a plurality of antennas laterally spaced within the spoiler housing.

7. A spoiler assembly according to any preceding claim, comprising a plurality of cellular antennas configured as a multiple-input and multiple-output (MIMO) cellular antenna array.

8. A spoiler assembly according to any preceding claim, wherein the radio unit further comprises transmission means for modulating a signal and providing it to the one or more antennas.

9. A spoiler assembly according to claim 8, wherein the transmission means is operable to modulate at least one of a 2G, 3G, 4G (LTE), 5G, GNSS, and V2X signal for transmission.

10. A spoiler assembly according to any preceding claim, wherein the signal processing means is arranged to provide an Ethernet signal.

11. A spoiler assembly according to claim 9, wherein the outputted data signal is a Broad R-Reach Ethernet signal.

12. A spoiler assembly according any preceding claim, wherein the signal processing means is operable to transmit and receive control signals via the data network.

13. A spoiler assembly according to any preceding claim, wherein the radio unit further comprises an eCall module for receiving and transmitting eCall signals.

14. A spoiler assembly according to any preceding claim, wherein the radio unit is a circuit formed on a printed circuit board.

15. A spoiler assembly according to claim 14, further comprising a circuit housing for enclosing the printed circuit board within the spoiler housing.

16. A spoiler assembly according to claim 14 or claim 15, wherein at least one antenna is formed on the printed circuit board.

17. A spoiler assembly according to any preceding claim, wherein at least one antenna is oriented vertically with respect to the spoiler and is arranged to extend downwardly from a surface of the spoiler housing.

18. A spoiler assembly according to claim 17, further comprising a lower portion of the spoiler housing that is arranged to enclose the one or more downwardly oriented antennas.

19. A spoiler assembly according to claim 18, wherein the lower portion is integrally formed with the upper portion of the spoiler housing.

20. A vehicle comprising a spoiler assembly according to any preceding claim.

21. A vehicle according to claim 20, further comprising a head unit located in the vehicle, said head unit comprising an electronic control unit for transmitting and receiving signals to and from the radio unit.

22. A vehicle according to claim 21, further comprising a wired network connection between the head unit and the radio unit.

23. A vehicle according to claim 22, wherein the vehicle further comprise a network switch configured to route signals on the wired network between the head unit and the radio unit.

24. A vehicle according to claims 22 and 23, wherein the wired network is an Ethernet network.

25. A vehicle according to claim 24 wherein the Ethernet network is a BroadR-Reach Ethernet network.
